(19) United States
(12) Patent Application Publication
(10) Pub. No.: US 2021/0330005 A1
(43) Pub. Date: Oct. 28, 2021

(54) ANTIVIRAL AND ANTIBACTERIAL FACE MASK

(71) Applicant: SRP Companies, Castle Rock, CO (US)

(72) Inventors: Christopher Scott Musso, Medina, MN (US); Darrin Eisele, Castle Rock, CO (US)

(21) Appl. No.: 17/240,545

(22) Filed: Apr. 26, 2021

Related U.S. Application Data
(60) Provisional application No. 63/015,379, filed on Apr. 24, 2020.

(51) Int. Cl. A41D 27/08; A41D 13/11; A62B 7/10; A62B 18/08; A62B 23/02; A62B 18/10; A62B 9/02

(52) U.S. Cl. CPC A41D 27/08; A41D 13/1192; A41D 13/1161; A62B 9/02; A62B 18/084; A62B 23/025; A62B 18/10; A62B 7/10

(57) ABSTRACT

Novel face masks are disclosed herein that blend required functionality of preventing the spread of communicable diseases with desirable and pleasing features that increase the acceptance of and desire to wear such face masks. The masks include an outer surface, a securing mechanism extending from the outer surface, and filtering media located underneath the outer surface. The securing mechanism can be pairs of ear straps or ear loops positioned over the user's ears to secure the face mask to the user's face. In another embodiment, the securing mechanism can be a pair of side bands that wrap around the user's head and fasten together at the back of the user's head to secure the face mask to user's face. When the face mask is secured to the user's face, the filtering media engages the face of a user to seal the user's mouth and nose from the surrounding environment.

### CROSS-REFERENCE TO RELATED APPLICATIONS

This application claims priority to U.S. Provisional Patent Application No. 63/015,379 titled “Antiviral and Antibacterial Face Mask” and filed on Apr. 24, 2021, the disclosure of this patent application being incorporated herein by reference in their entirety.

### FIELD OF INVENTION

The present disclosure generally relates to novel face masks that are effective in protecting a user against the airborne spread of viruses and bacteria. More specifically, the present disclosure relates to novel reusable face masks that include functional and aesthetically desirable designs and a filter portion that prohibits the transmission of viruses and bacteria through the filter portion.

### BACKGROUND

Throughout history humans have endured a continuous stream of health risks. In recent years there has been an increased focus on communicable diseases that can spread through a population without direct physical contact between an infected person and uninfected persons located nearby. Such communicable diseases are often spread when the infected person sneezes or coughs and generates airborne droplets of saliva or nasal discharge that contain communicable viruses and persons located nearby breath in these droplets. In modern society, personal interaction in densely populated areas can lead to a rapid spread of such communicable diseases. It is not difficult to imagine that a single infected person living in a crowded city can quickly spread a communicable disease. If such a single infected person typically uses public transportation during morning and evening commutes, stops by a crowded coffee shop and/or restaurant to purchase breakfast and dinner, and works an eight hour shift as clerk in the retail establishment or a server in a restaurant interacting with many customers, this single infected person could spread a virus to dozens or hundreds of people in a single day.

If a particular communicable viral or bacterial disease does not have effective testing methods or a vaccine and such disease is potentially deadly, society's options for controlling the spread of such a communicable disease can be limited. A government can recommend or enforce public policies such as social distancing, limiting gatherings to small numbers of people, limiting social and business interactions to only essential actives, or quarantining ill and even healthy citizens. However, each such public policy can cause significant economic disruption to the society. Such a difficult situation creates the need for governments to craft policies that balance the inherent tradeoffs between protecting the health of its citizens and limiting harm to the economy. It will be appreciated that products and methods that effectively limit the spread of communicable diseases during social and economic interactions can be very valuable in finding this balance between safeguarding public health and limiting harmful disruption to the economy.

In addition to recurring communicable diseases such as seasonal influenza, the common cold, and chickenpox, recent years have seen an increase in novel viruses for which there is no proven testing methods, treatment, or vaccines. For example, in 2009 and 2010, a novel strain of the influenza virus (influenza A virus subtype H1N1) cause pandemic level infections and deaths in certain parts of the world. Currently, a novel coronavirus (SARS-CoV-2) is causing even greater global effects and concern, which has caused nearly all governments to impose strict public policies directed at limiting the interaction of both those infected and those that are not infected with the virus. While such public policies are helpful in stemming the spread of the coronavirus, nearly all countries are experiences economic hardships in light of such public policies.

Any product that effectively slows or stops the spread of communicable diseases can play a role in facilitating more personal interaction during an epidemic or pandemic while protecting the users of the product against the spread of such disease. One general method of controlling the spread of communicable diseases is to create a physical barrier between persons that are directly interacting while separated by small distances. One such physical barrier is a face mask. Persons that are interacting can each wear a face mask to cover their mouth and nose to create physical barriers between the interacting persons. A face mask can protect both an uninfected person and can stop infected persons from subsequently spreading the disease. The use of face masks in public is becoming a more common and acceptable method of combating the spread of communicable diseases. However, the wholesale adoption of face masks remains allusive. Even though the health benefits appear to be understood, large segments of the population remain adverse to wearing face masks. Certain adults avoid wearing face masks because of elevated risk tolerance, herd mentality in advance of general adoption of face masks, the lack of visual appeal of face masks, and other such perception factors. Another challenge to the general use of face masks is that children, particularly young children, often dislike face masks. Children often fidget with and dislodge the face mask over time due to annoyance or discomfort. Thus, it can be a challenge to convince a child to properly wear a face mask for long periods of time.

Disclosed herein are novel arrangements for face masks that provide effective protection against the spread of communicable diseases, a comfortable fit and feel for users, and aesthetically desirable features that can appeal to the sensibilities of both adults and children, which results in people more readily accepting and wearing the novel face mask. The novel arrangement of face masks disclosed herein include all the functional requirements of a highly effective face mask and also include shapes, textures, logos, likenesses, and other features that people find inherently interesting. Many of these features are constructed using plush materials that further enhance the design. The results of this combination of functionality and aesthetically desirable features are face masks that are more readily adopted and used by a greater portion of the population.

### SUMMARY

The present disclosure describes several embodiments of novel face masks that blend the required functionality of preventing the spread of communicable diseases with aesthetically desirable and pleasing features that increase the acceptance of and desire to wear such novel face masks. The novel masks include an outer surface, a securing mechanism extending from the outer surface, and filtering media located underneath the outer surface. The securing mechanism can be pairs of ear straps or ear loops that are positioned over the user's ears to secure the face mask to the user's face. In another embodiment, the securing mechanism can be a pair of side bands that wrap around the user's head and fasten together at the back of the user's head to secure the face mask to the user's face. When the face mask is secured to the user's face, the filtering media engages the face of a user to seal the user's mouth and nose from the surrounding environment. The filtering media is arranged to effectively blocks viruses and bacteria from passing through the filtering media to the user's mouth or nose.

The outer surface can be constructed from a combination of breathable materials and plush materials. Each embodiment is arranged such that the breathable materials provide for the free flow of air through the outer surface and to the filtering media such that the outer surface does not in any way inhibit the breathing patterns of the user. Additionally, batting or other such stuffing materials can be used to create three-dimensional features on the outer surface of the face mask. In a number of embodiments, such three-dimensional features can resemble the facial features of animals in a manner that traditionally appeals to children. In other embodiments, the three-dimensional features can form sports mascots, pop-culture images, and other shapes that appeal to people of all ages. While plush materials and batting can be used, the face masks are constructed such that the sections of plush material and batting also allow for air to freely flow though the outer surface. In certain embodiments, portions of the outer surface that are constructed from breathable material, such as cotton, can include features and images that are printed onto the breathable material using techniques such as sublimation printing.

### BRIEF DESCRIPTION OF THE DRAWINGS

In the accompanying drawings, structures are illustrated that, together with the detailed description provided below, describe example embodiments of the disclosed systems, methods, and apparatus. Where appropriate, like elements are identified with the same or similar reference numerals. Elements shown as a single component can be replaced with multiple components. Elements shown as multiple components can be replaced with a single component. The drawings may not be to scale. The proportion of certain elements may be exaggerated for the purpose of illustration.

FIG. 1 schematically illustrates an exemplary embodiment of a face mask with ear straps for securing the face mask to a user's face.

FIG. 2 schematically illustrates an exemplary embodiment of a face mask with ear loops for securing the face mask to a user's face.

FIG. 3 schematically illustrates an exemplary embodiment of a face mask with side bands and hook and loop securing features for securing the face mask to a user's head.

FIG. 4 schematically illustrates an exemplary embodiment of a face mask with features resembling a face of a panther with ear loops for securing the face mask to a user.

FIG. 5 schematically illustrates an exemplary embodiment of a face mask with features resembling a face of a dog with ear straps for securing the face mask to a user.

FIG. 6 schematically illustrates an exemplary embodiment of a face mask with features resembling a face of a dinosaur with side bands for securing the face mask to a user.

FIG. 7 schematically illustrates an exemplary embodiment of a face mask with features resembling a face of a cat with side bands for securing the face mask to a user.

FIG. 8 schematically illustrates an exemplary embodiment of a face mask with features resembling a face of a cat with ear straps for securing the face mask to a user.

FIG. 9 schematically illustrates an exemplary embodiment of a face mask with features resembling a face of a monkey with ear loops for securing the face mask to a user.

FIG. 10 schematically illustrates an exploded view of the face mask of FIG. 9.

FIG. 11 schematically illustrates an exemplary embodiment of a face mask with features resembling a face of a dinosaur with side bands for securing the face mask to a user.

FIG. 12 schematically illustrates a variety of face mask designs with ear loops for securing the face masks to a user.

FIG. 13 schematically illustrates a variety of aesthetic designs for use with a face mask.

FIG. 14 schematically illustrates a variety of aesthetic designs for use with a face mask.

FIG. 15 schematically illustrates a variety of aesthetic designs for use with a face mask.

FIG. 16 is a photograph depicting a child wearing an exemplary embodiment of a face mask with features resembling the face, trunk, and front legs of an elephant.

FIG. 17 is another photograph depicting a child wearing the face mask of FIG. 16.

FIG. 18 is yet another photograph depicting a child wearing the face mask of FIG. 16.

FIG. 19 is a photograph depicting a child wearing an exemplary embodiment of a face mask with features resembling the whimsical facial features of a fanciful monster.

FIG. 20 is another photograph depicting a child wearing the face mask of FIG. 19.

### DETAILED DESCRIPTION

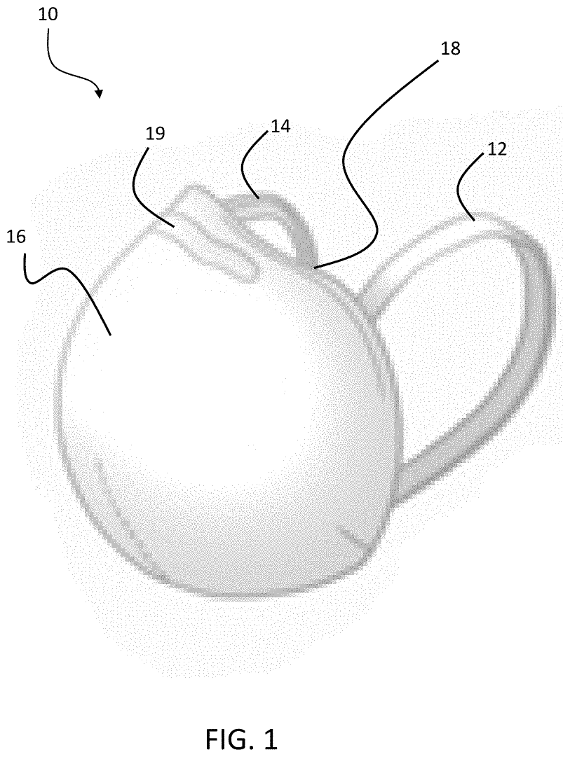

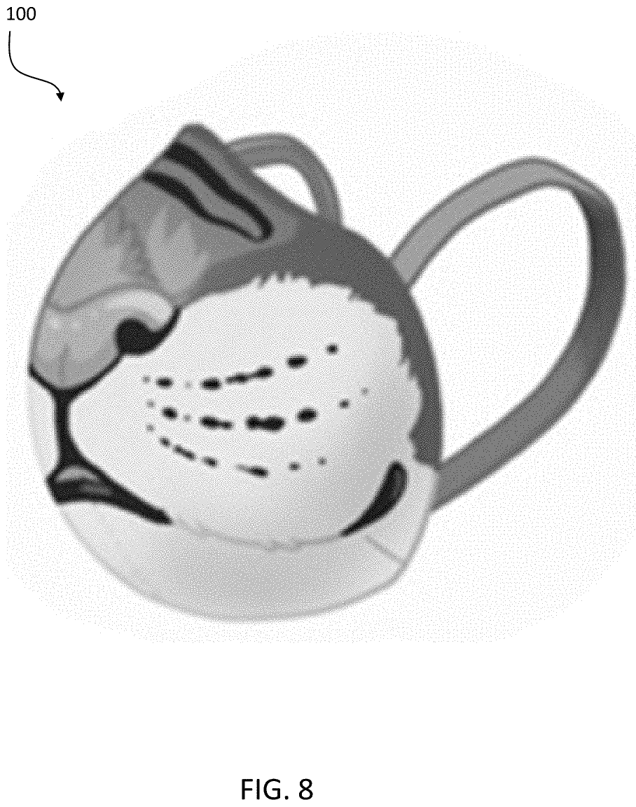

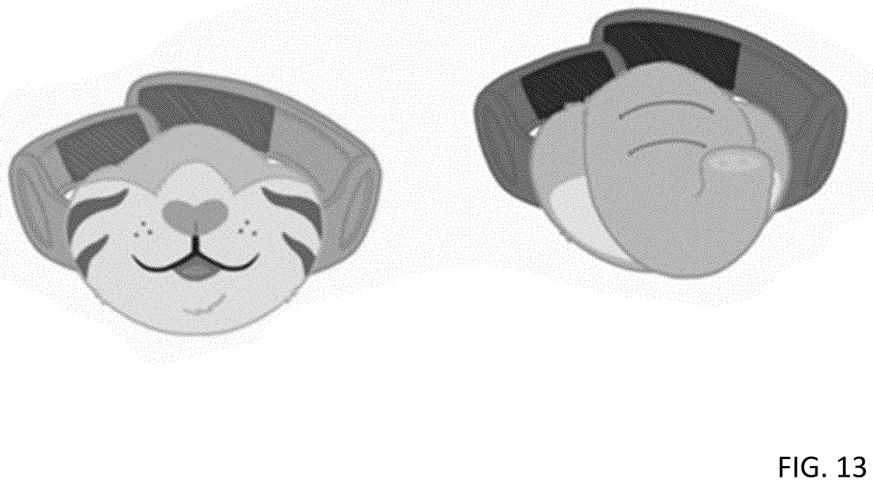

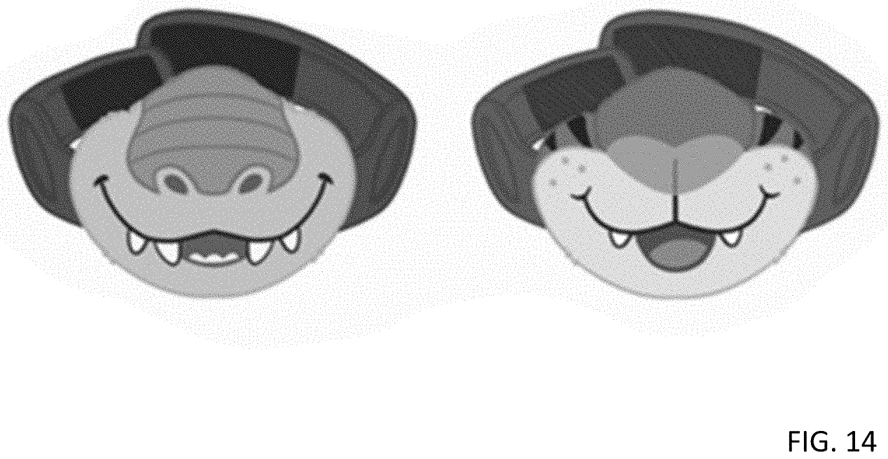

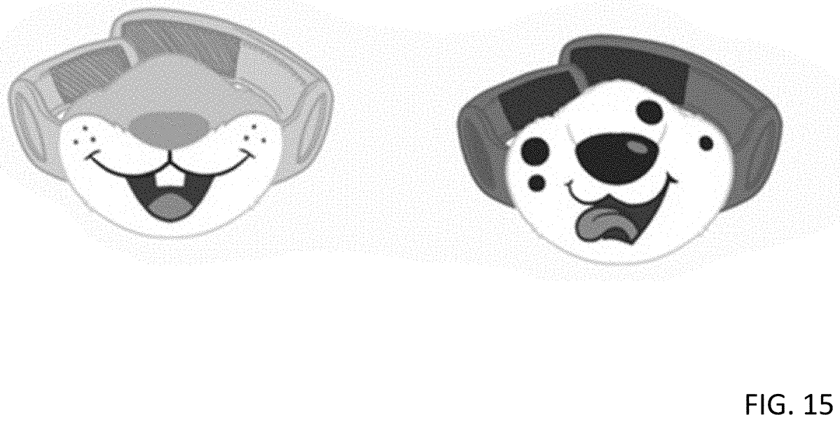

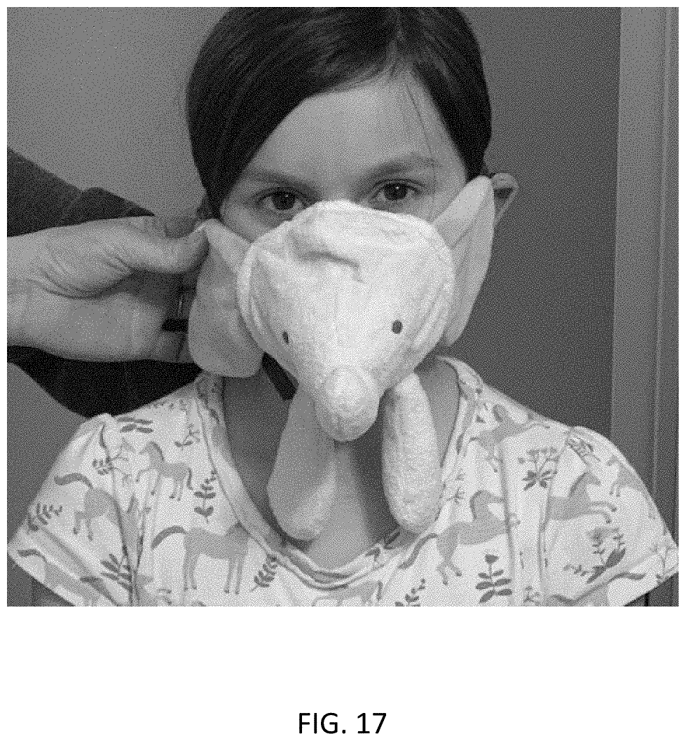

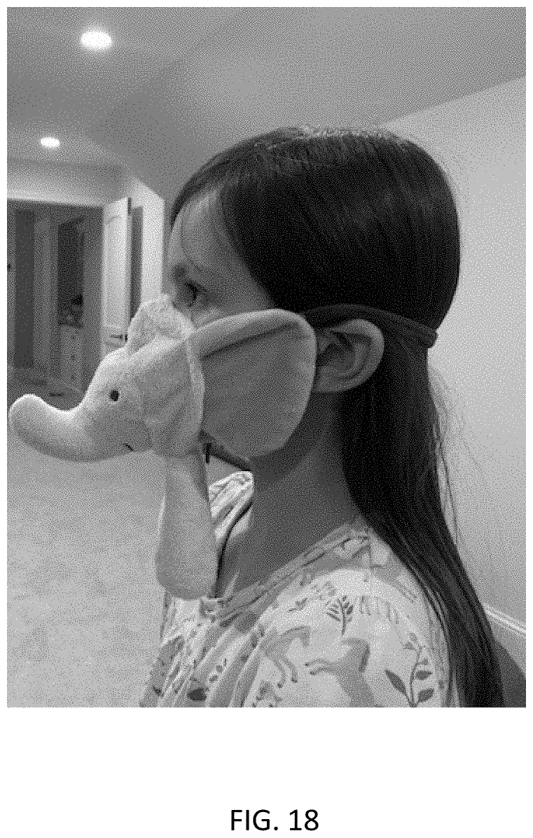

The apparatus, systems, arrangements, and methods disclosed in this document are described in detail by way of examples and with reference to the figures. It will be appreciated that modifications to disclosed and described examples, arrangements, configurations, components, elements, apparatus, methods, materials, etc. can be made and may be desired for a specific application. In this disclosure, any identification of specific techniques, arrangements, method, etc. are either related to a specific example presented or are merely a general description of such a technique, arrangement, method, etc. Identifications of specific details or examples are not intended to be and should not be construed as mandatory or limiting unless specifically designated as such. Selected examples of apparatus, arrangements, and methods for using antiviral and antibacterial face masks are hereinafter disclosed and described in detail with reference made to FIGS. 1-20.

Disclosed herein are novel face masks that prevent the transmission of airborne viruses and bacteria to a user of the face mask. The novel face masks include overall designs that create a comfortable fit for the user of the face mask, which will promote greater acceptance and continuous use of the face masks. Certain embodiments include aesthetically desirable features and designs that can appeal to certain users that will further increase the acceptance and continuous use of the face masks. Certain embodiments disclosed herein are reusable. In one example, a face mask can be washed between uses and in other examples, the face masks can be arranged with disposable filter media that is replaced between uses. Generally, the considerations informing the design of the novel face masks disclosed herein include safety of the user, breathability of the face mask, correct fit and seal of the face mask, and comfort of the user.

With those considerations in mind, the materials selected for the face masks are generally lightweight, but durable, and breathable. One specific goal is to create face masks that include more complexity and features than prior art masks but do not in any way inhibit the breathing patterns of the user of the face mask. The materials are generally washable to provide for reuse of the face masks. In certain embodiments, the filtering media is also washable, in which case, the filtering media can be uses for the duration of the lifecycle of the face mask. In another embodiment, the filtering media is robust and can be washed or cleaned a number of times, which requires only periodic replacement of the filtering media. In yet another embodiment, the filtering media is disposable and is replaced after each use.

In a number of embodiments, the filtering media is integral to the face mask and, while it can be replaced, is generally securely positioned within the face mask so that the filtering media is properly placed over the user's mouth and nose when the face mask is secured to the user's face. Certain materials used for face masks disclosed herein include, but are not limited to: breathable cotton material; plush material, such as a low pile polyester fabric; pliable structural materials, such as cotton batting and other stuffing materials; and rugged elastic or elastomeric materials such as thin sheeting of natural or synthetic rubbers. The various components of the face masks can be secured or otherwise attached to each other through traditional manufacturing techniques such as sewing, gluing, hot-melting, pressing, and the like. Additionally, the materials used to construct face masks disclosed herein can be treated or coated with antiviral and/or antibacterial agents to increase the effectiveness of the face masks.

FIGS. 1-3 schematically illustrate three styles of face masks that will serve as the basis for the novel face masks disclosed herein. These initial three figures serve to illustrate the general designs of novel face masks disclosed herein. As will be further discussed in detail, the novel face masks include outer layers that form features including plush features. Many of the features are three-dimensional in nature and are formed using batting, wadding, and other such filler materials positioned between sheet of fabric and the application of certain sewing techniques that enhance the three-dimensional nature of the features.

FIG. 1 illustrates a first embodiment of a face mask 10 that includes a pair of ear straps 12, 14 and a filter portion 16. The first ear strap 12 is secured about the left ear of a user and the second ear strap 14 is secured about the right ear of the user to secure the face mask 10 to the user's face. Once the face mask 10 is secured to the face of the user, the filter portion 16 is properly and securely positioned over the user's nose and mouth. The ear straps 12, 14 can be constructed of a generally elastic material to facilitate the positioning and securing of the ear straps 12, 14 about the user's ears. The perimeter 18 of the filter portion 16 that engages the user's face can also include an elastic strip that facilitates the sealing of the face mask 10 to the user's face. The face mask 10 can further include a nose clip 19 designed to be positioned on the bridge of the user's nose to further seal the filter portion to the user's face.

In this embodiment and subsequent embodiments, the filter portion is constructed of a filtering media that blocks and prohibits the transmission of airborne viruses and bacteria through the filtering media. In one example, the filter portion can be constructed from a flexible non-woven fabric that is formed using a melt blowing process. Such fabrics can be constructed from polypropylene, polystyrene, and polyesters fibers. In another example, any material can be used that yields a filter portion that blocks the transmission of at least 95% of airborne particles that are 0.3 micrometers or larger in size (typically designated as N95 materials).

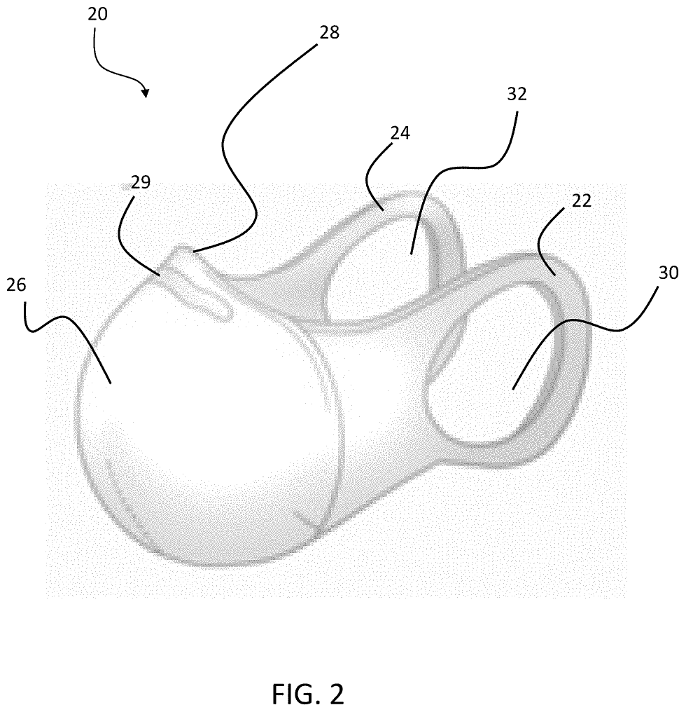

FIG. 2 illustrates a second embodiment of a face mask 20 that includes a pair of ear loops 22, 24 and a filter portion 26. The first ear loop 22 is secured about the left ear of a user and the second ear loop 24 is secured about the right ear of the user to secure the face mask 20 to the user's face. Once the face mask 20 is secured to the face of the user, the filter portion 26 is properly and securely positioned over the user's nose and mouth. Each ear loop 22, 24 includes an aperture 30, 32 to accommodate the user's ears when secure the loop 22, 24 about the user's ear. The ear loops 22, 24 can be constructed of an elastomer with significant structural integrity such as, for example, natural rubber, Neoprene®, and the like. The elastomeric properties of the ear loops 22, 24 provide for a secure and comfortable fit for the user. As with previous descripting, the perimeter 28 of the filter portion 26 can include an elastic portion that facilitates the sealing of the face mask 20 to the user's face, and the face mask 20 can further include a nose clip 29 designed to be positioned on the bridge of the nose to further seal the face mask 20 to the user's face.

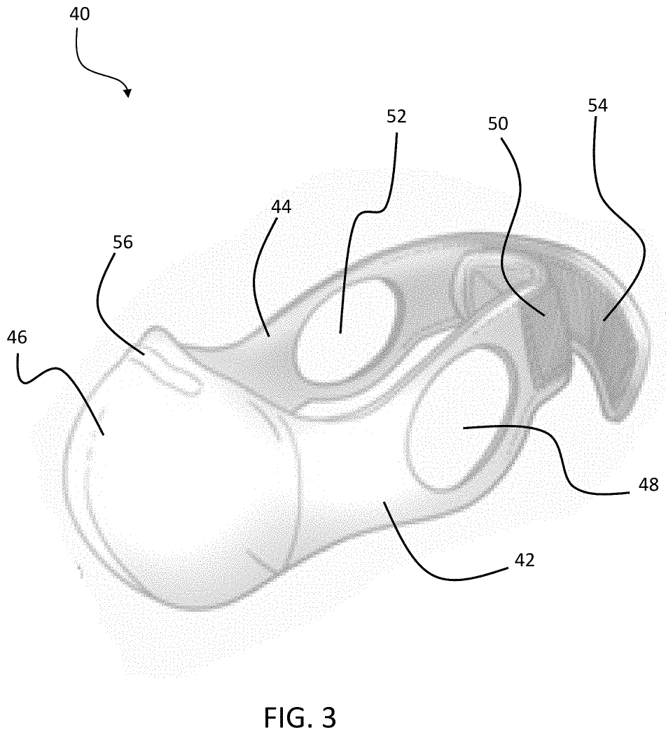

FIG. 3 illustrates a third embodiment of a face mask 40 that includes a left side band 42, a right side band 44, and a filer portion 46. The left side band 42 includes an ear aperture 48 and a securing portion 50 positioned near the distal end of the left side band 42. The right side band 44 includes an ear aperture 52 and a securing portion 54 positioned near the distal end of the right side band 44. The side bands 42, 44 can be constructed from any number of materials. In one example, the side bands 42, 44 are constructed of an elastomer with significant structural integrity such as, for example, natural rubber or a synthetic rubber such as Neoprene®. In other examples, the side bands 42, 44 can be constructed from cotton, rayon, polyester, nylon, and other similar fabrics. In yet another example, the side bands 42, 44 or a portion of the side bands 42, 44 can be constructed from an elastic strip, rope, or cord. The face mask 40 is secured to a user by first placing the filter portion 46 over the mouth and nose of the user, wrapping the left side band 42 along the left side and back of the user's head and positioning the user's left ear through the ear aperture 48. Then the right side band 44 is wrapped along the right side and back of the user's head, positioning the user's right ear through the ear aperture 52, and engaging the securing portions 50, 54 to snuggly and securely attach the face mask 40 to the user's head. The securing portions 50, 54 of the side bands 42, 44 can comprise any number of securing mechanisms. For example, the securing portions 50, 54 can together form a hook and loop securing system (as illustrated in the figures). In other examples, the face mask 40 can be secured to the user's head with a button and slot system, hook and eye system, a series of snap fasteners, or simply by typing the ends of the left 42 and right 44 side bands. As previously noted, a nose clip 56 is included to further seal the face mask 40. As will be appreciated, with the design illustrated in FIG. 3, the face mask 40 is securely fastened to the user's head and face. As shown by the examples provided herein, the securing portions can be arranged to allow for adjusting how tightly face mask 40 is secured to the user's face, and the ear apertures 48, 52 expose the user's ears so that there is no interference with the user hearing surrounding sounds.

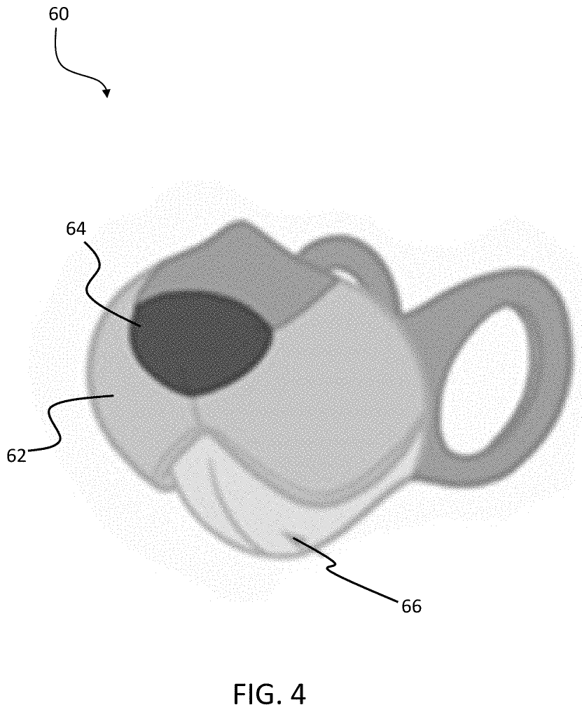

As previously noted, the face masks can include aesthetically desirable features and designs that also include functional features. Such designs are schematically illustrated in FIGS. 4-15. As illustrated, many of the features are three-dimensional in nature and are formed by placing batting, wadding, and other such filler materials between layers of fabric coupled with the application of certain sewing techniques to enhance the three-dimensional nature of the features. Generally, the designs illustrated in FIGS. 4-15 are intended to appeal to children and young teenagers to increase the acceptance and use of face masks by this group of people. However, it will be appreciated that there are a multitude of designs that can also appeal to adults. For example, face masks can include logos and insignias of professional or college sports teams; images or likenesses of popular pop-culture characters such as singers, actor, and characters from Star Wars, Marvel Comics, DC Comics, and Disney; and indicia of political affiliation. The examples provided herein are simply exemplary embodiments and this disclosure contemplates a broad variety of aesthetic designs for face masks.

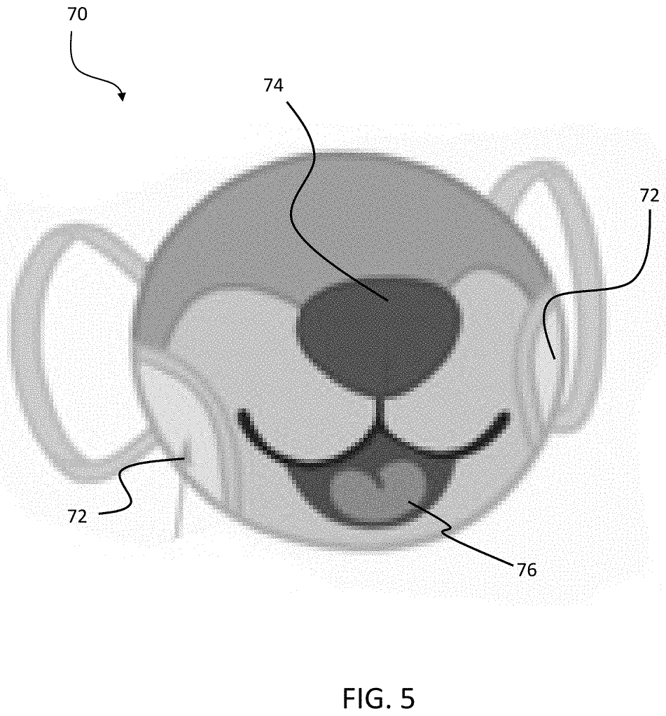

FIGS. 4 and 5 illustrate face masks 60, 70 with aesthetic features that resemble the facial features (generally the muzzle) of a panther and dog respectively. Such face masks 60, 70 can be appealing to children, which promotes greater general acceptance to wearing the face mask as well as encouraging the child to more consistently keep the face mask properly positioned over his or her mouth and nose. As will be subsequently described in greater detail, the aesthetic features can be constructed from combinations of lightweight highly-breathable and plush materials supported by batting material to create a three-dimensional shape that best represents the desired features.

In one example, the face mask 60 illustrated in FIG. 4 includes an outer layer that mimics the cheek 62, nose 64, and mouth 66 features of a panther. Low pile polyester fabric material (commonly referred to as velboa) can be used to construct the cheeks 62 and nose 64 features of the outer layer of the face mask 60, while the mouth portion 66 of the outer layer of the face mask 60 can be constructed from lightweight ultra-breathable cotton fabric. The face mask 60 can further include an inner layer of breathable cotton or similar fabric that engages with the user's face. Cotton wadding or similar batting or stuffing material can be positioned between the inner layer and outer layer of the face mask 60 to provide structure and stability for the three-dimensional shape of the face mask 60. Such an arrangement maintains the desired three-dimensional shape while remaining flexible and pliable for the comfort of the user. The filter portion is secured to the inner layer of the face mask 60 such the filter portion is positioned over the mouth and nose of the user and sealed to the face of the user when the face mask is secured to the user's face. The lightweight ultra-breathable cotton fabric that forms the mouth feature 66 provides for sufficient air flow through the outer layer of the face mask 60 so that the outer layer does not in any way inhibit air flow through the face mask 60.

In another example, the face mask 70 illustrated in FIG. 5 includes an outer layer that mimics cheek 72, nose 74, and mouth 76 features of a dog. Low pile polyester fabric material is used to construct the nose 74 and mouth 76 features (and areas around the nose 74 and mouth 76 features) of the outer layer of the face mask 70, while the cheek features 72 of the outer layer of the face mask 70 are constructed from lightweight ultra-breathable cotton fabric. As in previous description, the face mask 70 can further include an inner layer of breathable cotton or similar fabric that engages with the user's face. Cotton wadding can be positioned between the inner layer and outer layer of the face mask 70 to provide structure and stability for the three-dimensional shape of the face mask 70. The filter portion is secured to the inner layer of the face mask 70 such the filter portion is positioned over the mouth and nose of the user and sealed to the face of the user. The lightweight ultra-breathable cotton fabric that forms the cheek features 72 provides for sufficient air flow through the outer layer of the face mask 70 so that the outer layer does not in any way inhibit air flow through the face mask 70.

It will be understood that outer surfaces of face masks can be designed such that portions of the outer surface are constructed from plush material and cotton wadding, while other portions of the outer surface are constructed from breathable materials such as cotton. Each designs take into consideration the overall surface area covered by breathable cotton and the overall surface area covered by plush material and the relative positioning of those areas compared to the filtering media and the mouth and nose of the user. While the plush material and cotton wading allow for the passage of air, the breathable cotton is better suited for this function. Therefore, the face mask designs disclosed herein include breathable material positioned proximate to the filtering media and/or the user's mouth and nose.

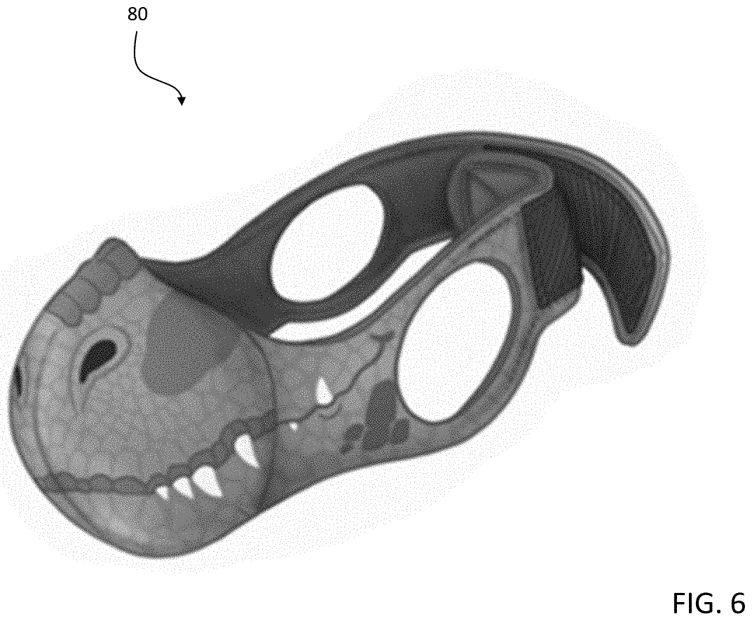

FIGS. 6-8 illustrate additional examples of face masks (80, 90, and 100). In these three examples, the outer layers of the face masks (80, 90, and 100) are constructed of breathable cotton material with the features printed onto the cotton material using sublimation printing. As previously described, the face masks (80, 90, and 100) each include an inner layer constructed from breathable cotton that engages the user's face, cotton batting optionally positioned between portions of the inner and outer layers, and a filter portion positioned over the user's nose and mouth. In these examples, the outer layers of the face masks (80, 90, and 100) and cotton batting allow for the free flow of air through the face mask (80, 90, and 100) so that the user's breathing is not labored, and the filter portion effectively blocks the transmission of viruses and bacteria into the nose and mouth of the user.

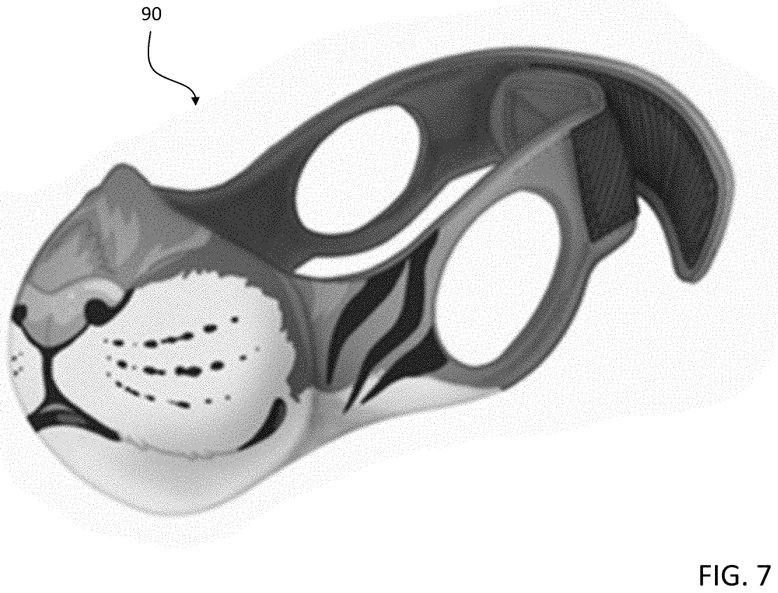

It will be understood that sublimation printing provides variety in the types of patterns, images, and features that can be printed onto the breathable sections of face masks. Such a method can allow for many different aesthetic designs to be applied to face masks. It will be noted that the face mask style illustrated in FIGS. 6 and 7 provide a substantial amount of visible breathable material for adding to and supplementing such aesthetic designs.

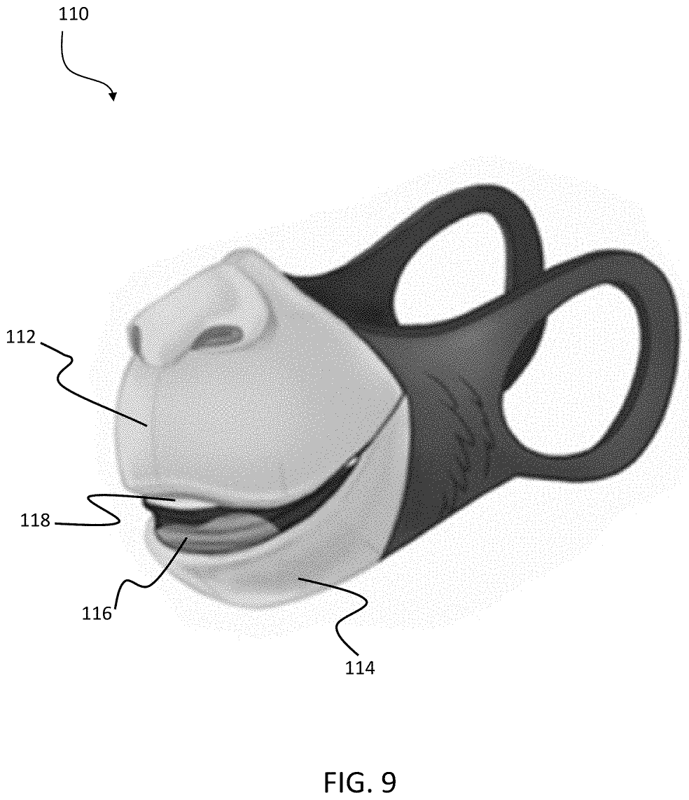

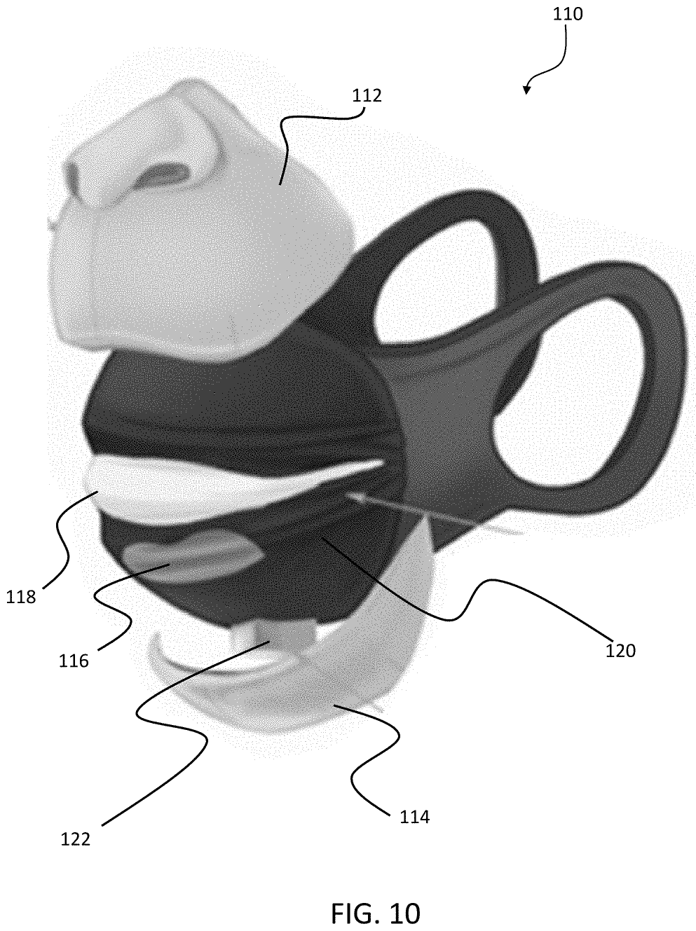

FIGS. 9 and 10 illustrate an additional example of a face mask 110, with FIG. 10 showing an exploded version of the face mask 110 to reveal certain internal features and structures. The illustrated face mask 110 is designed to mimic the lower half a monkey's face. The features include an upper jaw 112, a lower jaw 114, a tongue 116, and teeth 118. The face mask 110 is constructed so that the upper jaw 112 and lower jaw 114 can move relative to one another. As will be generally understood, traditional face masks such as surgical masks often included pleats that allow the surgical mask to expand and contract and maintain a proper seal to accommodate the movement of the user's mouth and nose while taking, sneezing, coughing, and the like. The face mask 110 illustrated in FIGS. 9 and 10 include such an ability to expand and contract to accommodate the movement of the filter portion of the face mask 110 when users talk, sneeze, and cough.

The upper 112 and lower 114 jaws are made of an outer layer of plush material, such as a low pile polyester fabric material, and an inner layer of cotton or similar material. The upper 112 and lower 114 jaws are filled with cotton batting to provide shape, support, and structure to the upper 112 and lower 114 jaws. An interior cup shaped portion 120 of the face mask 110 (illustrated in FIG. 10), is constructed from breathable cotton material. The interior cup shape portion 120 can include pleats to allow the interior cup shaped portion 120 to flex along with the movement of the user's mouth and nose. Features can be printed onto the breathable cotton of the interior cup shaped portion 120. For example, a section can be printed with a deep red color to mimic the inside of the cheeks of a monkey, a section can be printed with a pink color to mimic the tongue 116 of the monkey, and a section can be printed with a white color (or left white if that is the color of the cotton materials) to mimic the teeth 118 of the monkey. Alternatively, a gap can be left in the interior cup shape portion 120 to reveal a portion of the filter portion, which can itself be white, to mimic the teeth of the monkey.

Additional internal structures can be used, such as a foam block 122 (illustrated in FIG. 10) that provide support and structure of the face mask 110. In this instance, the foam block 122 supports the lower jaw 114 of the face mask 110. As will be understood, once the face mask 110 is secured to the user's face, the user can speak, sneeze, and cough and the face mask 110, and its filter portion, can flex to accommodate such movement of the user's mouth and nose while remaining sealed. Additionally, it will be understood that the breathable cotton material used to construct the interior cup shaped portion 120 of the face mask 110 allows free movement of air through the face mask 110 so that the user's breathing is not inhibited in any way.

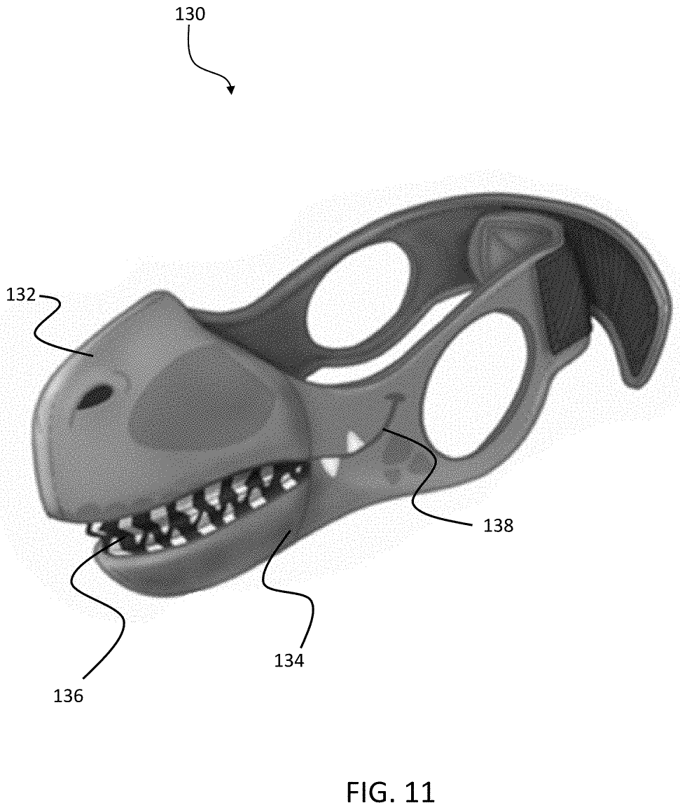

FIG. 11 illustrates a face mask 130 that is similar to the face mask 120 illustrated in FIGS. 9 and 10. The face mask 130 includes an upper jaw 132 and a lower jaw 134 arranged to move relative to one another. The face mask 130 further includes a connection section 136 and a groove 138 located on each side of the face mask 130 (only one groove, on the left side of the face mask 130, is shown in FIG. 11). The upper 132 and lower 134 jaws can be constructed from an outer layer of plush material, an inner layer of cotton, and cotton batting positioned between the outer and inner layers. Alternatively, the upper 132 and lower 134 jaws can be constructed from breathable cotton material with features printed onto the cotton material using sublimation printing. The connection section 136 can be constructed from a breathable cotton and includes a number of pleats. The connection section 136 is secured to both the upper 132 and lower 134 jaws and allows relative movement between the upper 132 and lower 134 jaws. The grooves 138 in the side band regions of the face mask 130 additionally facilitates relative movement between the upper 132 and lower 134 jaws. Whether the connection section 136 alone or the upper 132 and lower 134 jaws are constructed from breathable cotton fabric, the face mask 130 does not inhibit the user's breathing in any way.

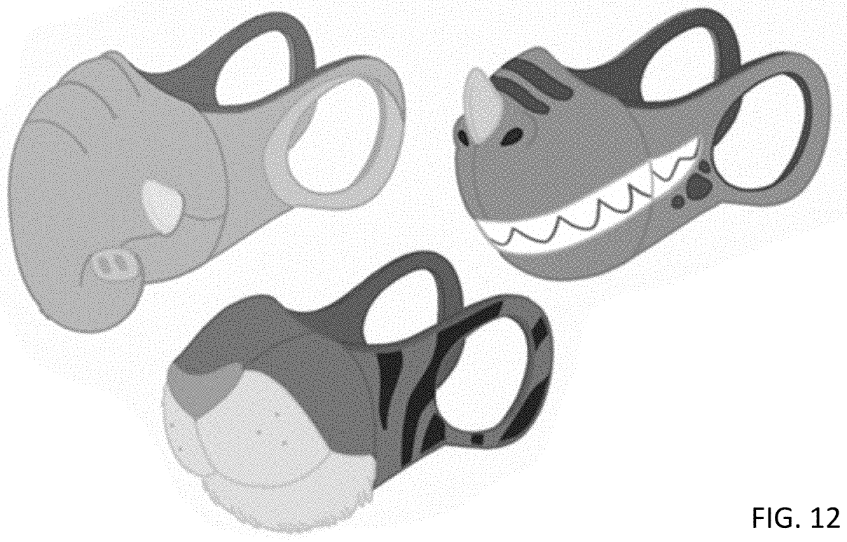

FIGS. 12 through 15 illustrate additional aesthetic designs for face masks. Each such facemask can be constructed from a combination of plush material, cotton batting, and breathable cotton material, or just from breathable cotton material. Each design also includes a securing mechanism to secure the face mask to the user's face and includes in integrated filter portion to cover the user's mouth and nose. Such arrangements provide protection for the user from airborne viruses and bacteria without inhibiting the breathing of the user.

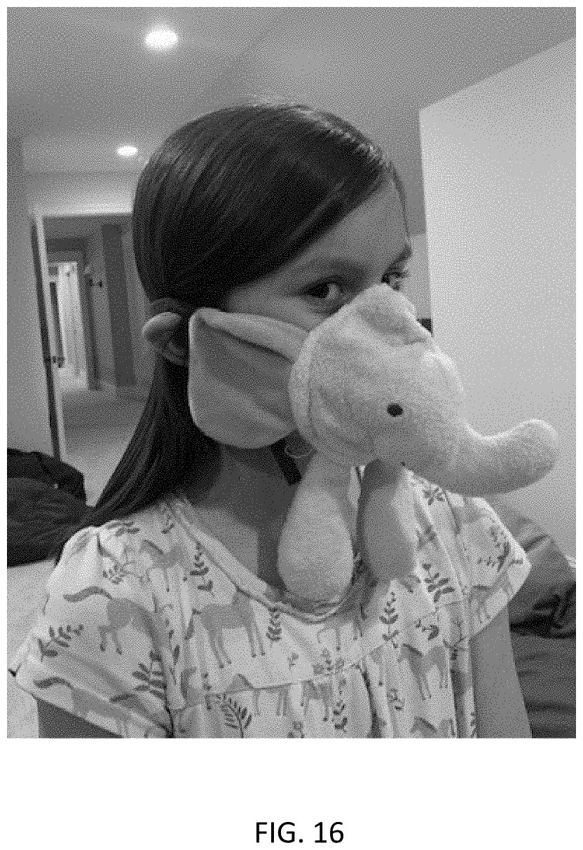

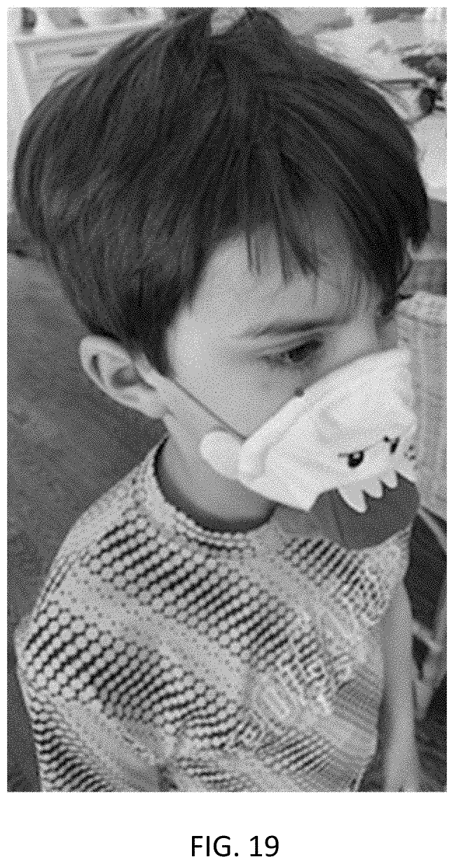

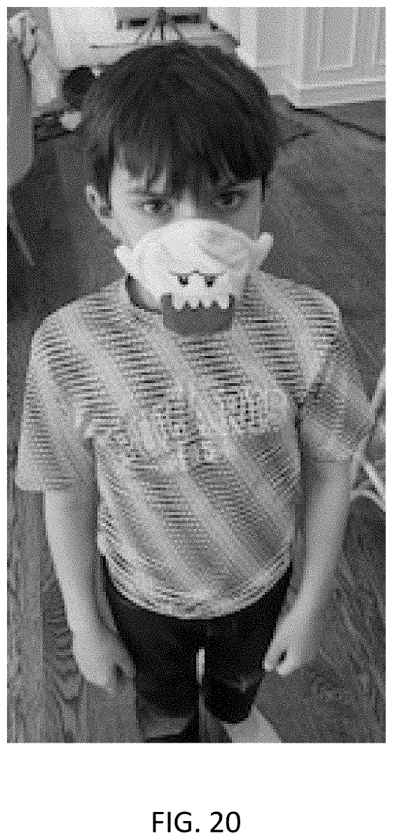

FIGS. 16-20 are photographs depicting children wearing face masks with plush three-dimensional features that represent designs that typically appeal to children. FIGS. 16-18 depict a child wearing a face mask with features resembling the face, trunk, and front legs of an elephant. As is shown, the outer texture of the face mask is plush and appealing to the touch. The trunk of the elephant is stuffed with batting and sewed using techniques that cause the trunk to extend outward from the face of the elephant. The legs are also stuffed with batting to provide three-dimensional structure. However, the legs are sewn in a way that allows the legs to gently sway as the user moves about. FIGS. 19 and 20 depicting a child wearing a face mask with features resembling whimsical facial features of a fanciful monster. The design emphasizes a prominent tongue extending from the mouth of the monster. The tongue is three-dimensional in nature and is constructed from batting between two layers of material. The sewing techniques provide for the tongue to extend rigidly away from the face mask. The examples depicted in FIGS. 16-20 are but two more examples of novel and inventive face masks with plush three-dimensional features covered by this disclosure.

Additional useful features can be incorporated into the face masks described herein. In one example, an exhalation valve (i.e., a one-way valve) can be incorporated into or coupled with the filtering media. Such a valve provides for air exhaled by the user to escape through the valve but does not allow inhaled air to travel through the valve. All inhaled air breathed by the user will continue to be transmitted through the filtering media. Such an exhalation valve can increase the comfort and service life of the face masks. Allowing exhaled breath to escape dissipates heat, humidity, and carbon-dioxide that can otherwise become trapped behind the filtering media and stagnate about the user's nose and mouth. The elimination or reduction of such heat, humidity, and carbon-dioxide not only increases the comfort level for the user, but likely results in the user wearing the face mask more consistently and for longer periods of time. Additionally, heat and humidity can over time breakdown certain components of the face mask. Thus, the elimination or reduction of such heat and humidity can increase the useful service life of the face mask. The exhalation valve can be incorporated into certain features of the outer layer of the face masks. For example, the exhalation valve can be incorporated into a nose feature, mouth feature, or teeth feature for the animal mimicked by the face mask.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

We claim:

1. An antiviral and antibacterial face mask comprising:
an outer surface comprising one or more features;
a securing mechanism extending from the outer surface;
an inner surface; and
filtering media secured to the inner surface.

2. The antiviral and antibacterial face mask of claim 1, further comprising batting positioned between the outer surface and the inner surface arranged to form the one or more features as a three-dimensional feature.

3. The antiviral and antibacterial face mask of claim 2, wherein outer surface comprises a combination of plush material and breathable material.

4. The antiviral and antibacterial face mask of claim 2, wherein the three-dimensional feature is modeled on a feature of an animal.

5. The antiviral and antibacterial face mask of claim 2, wherein the three-dimensional feature is modeled on a feature of a mascot.

6. The antiviral and antibacterial face mask of claim 1, wherein the securing mechanism comprises a first ear strap extending from a first side of the outer surface and a second ear strap extending from a second side of the outer surface.

7. The antiviral and antibacterial face mask of claim 1, wherein the securing mechanism comprises a first ear loop extending from a first side of the outer surface and a second ear loop extending from a second side of the outer surface.

8. The antiviral and antibacterial face mask of claim 1, wherein the securing mechanism comprises a first band extending from a first side of the outer surface and a second band extending from a second side of the outer surface.

9. The antiviral and antibacterial face mask of claim 1, wherein the one or more features comprises a sublimation printed image on the outer surface.

10. The antiviral and antibacterial face mask of claim 1, further comprising an exhalation valve coupled to the filtering media.
